(19) United States
(12) Patent Application Publication
(10) Pub. No.: US 2012/0298925 A1
(43) Pub. Date: Nov. 29, 2012

(54) ELECTROSTATIC DISCHARGE POLYMER FILLER CONTAINING CARBON NANOTUBE ENCLOSED WITH THERMOPLATIC RESIN LAYER AND MANUFACTURING METHOD THEREOF

(75) Inventors: Soowan Kim, Daejeon (KR); Sangpil Kim, Daejeon (KR); Changwon Lee, Seoul (KR)

(73) Assignee: HANNANOTECH CO., LTD., Daejeon (KR)

(21) Appl. No.: 13/512,460

(22) PCT Filed: Dec. 14, 2011
(86) PCT No.: PCT/KR2011/009606

§ 371 Date: May 29, 2012

(30) Foreign Application Priority Data
Jan. 19, 2011 (KR) 10-2011-0005525

(51) Int. Cl. H01B 1/04; H01B 1/02; B82Y 30/00; B82Y 40/00

(52) U.S. Cl. 252/503; 252/511; 977/742; 977/773; 977/750; 977/752; 977/810; 977/842

(57) ABSTRACT

The present invention relates to an electrically conductive polymer filler for preparing electrically conductive plastics and a preparation method thereof. More specifically, the invention relates to an electrically conductive polymer filler comprising carbon nanotube (CNT) microcapsules including carbon nanotubes encapsulated with a thermoplastic resin layer, and to a preparation method and an electrically conductive thermoplastic resin comprising the electrically conductive polymer filler.

### TECHNICAL FIELD

The present invention relates to an electrically conductive polymer filler for preparing electrically conductive plastics and a preparation method thereof. More specifically, the present invention relates to an electrically conductive polymer filler comprising carbon nanotube (CNT) microcapsules including carbon nanotubes encapsulated with a thermoplastic resin layer, and to a preparation method and an electrically conductive thermoplastic resin comprising the electrically conductive polymer filler.

### BACKGROUND ART

Because polymers are easy to mold, have excellent chemical resistance and are light in weight, they are used in various applications, including automobile parts, electrical/electronic parts, construction materials, and packaging materials. However, these polymers basically have insulating properties, and thus can experience problems, such as electric discharge, attraction and repulsion, after the generation of static electricity by friction. Accordingly, in order to remove or neutralize generated static electricity, these polymers are required to have the property of dispersing or dissipating charging static electricity. Electrostatic discharge (ESD) polymers are electrically conductive polymer materials provided with electrostatic dissipative properties by various methods while maintaining fundamental polymer properties. The ESD polymers have a surface resistivity of about 10⁴⁻¹⁰ Ω/sq, and thus have the electrostatic dissipative property of dissipating static electricity generated by friction.

In general, methods for imparting antistatic properties to polymers include the following methods: (1) a method in which a low-molecular-weight antistatic agent is added to resin or coated on the resin surface before the production of a product; (2) a method in which electrically conductive fillers such as carbon-based materials, metals, particles and electrostatic discharge polymers are dispersed in polymers; and (3) a method in which the molecular structure of materials becomes a conductive polymer structure.

In addition, there is a method in which a carbon-based or polymer-based conductive filler is used depending on the required level of the surface resistivity of final products such that it can perform not only an antistatic function, but also an electrostatic dissipative function.

Among the above-described methods, the method that uses the electrically conductive polymer has problems of low price competitiveness and resin instability.

Examples of the method in which the antistatic agent is added to or coated on polymer resin are as follows. Korean Patent Laid-Open Publication No. 1997-0006325 discloses a method in which an antistatic agent is applied to the surface of thermoplastic resin and then dried before the production of a product. However, this method has shortcomings in that the additive moves to the surface of the product with the passage of time so as to be transferred to other products, and deteriorates the physical properties of the resin, such as strength and elongation, and the antistatic property thereof and the durability of the antistatic property are insufficient. Korean Patent Laid-Open Publication No. 1998-0068341 discloses a method for preparing a thermoplastic resin, in which carbon fiber, talc and glass fiber are added to an aromatic polyethersulfone resin and a polycarbonate resin in order to improve the electrical conductivity, dimensional stability, mechanical strength, heat resistance and processability of the resins. In this method, carbon fiber and talc are used in an amount of 30 wt % or more based on the weight of the resins such that the resins exhibit electrical conductivity. However, this method has a problem in that the other physical properties of the resins are deteriorated, because the fillers are used in a large amount.

With respect to the method that uses the conductive fillers, carbon black and carbon fiber among conductive fillers are most widely used, but are not satisfactory in terms of performance. In recent years, carbon nanotube materials have received attention as fillers in terms of electrical conductivity. However, carbon nanotube particles are difficult to disperse, and even if they are dispersed in resin, the uniform dispersion thereof in the resin is very difficult to maintain, because they have a strong tendency to agglomerate together. In addition, the electrostatic properties of carbon nanotubes in matrix resin are insufficient due to the insufficient adhesion between the matrix resin and the carbon nanotubes.

In attempts to solve such problems, many papers and patents relating to the chemical modification and dispersion of carbon nanotubes have been presented or published. Previous study papers showed that the dispersion of carbon nanotubes can be increased by simple physical treatment. In addition, methods of preparing a carbon nanotube dispersion liquid using ultrasonication or a surfactant were reported. However, in these methods, carbon nanotubes are sufficiently dispersed by a single step, and the dispersion stability of carbon nanotubes is also poor. Particularly, in these methods, when other additives are added to carbon nanotubes, the dispersion of the carbon nanotubes becomes unstable so that the carbon nanotubes tend to agglomerate. When these carbon nanotubes are mixed with resin, they are not uniformly dispersed in the resin, and thus the electrical and physical properties of the carbon nanotube/resin mixture are deteriorated.

Meanwhile, examples of patents relating to the use of carbon nanotubes as electrically conductive fillers are as follows.

In examples of the use of carbon nanotubes as electrically conductive fillers, Korean Patent Laid-Open Publication No. 2010-0058342 discloses an electrically conductive resin composition comprising, based on 100 parts by weight of a thermoplastic resin, 0.1-5 parts by weight of surface-modified carbon nanotubes and 1-20 parts by weight of a carbon compound. However, as mentioned above, the resin composition is difficult to disperse uniformly in the resin, and thus does not exhibit sufficient electrostatic properties.

Korean Patent Laid-Open Publication No. 2002-0095273 discloses an electromagnetic wave shielding coating material composed of polyvinylidene fluoride, polyvinylpyrrolidone, N-methylpyrrolidone, and carbon nanotubes, and a preparation method thereof. However, there is a problem in that the field of application of the coating material is limited. Furthermore, Korean Patent Laid-Open Publication No. 2005-0097711 discloses a very complicated method which comprises making carbon nanotubes having one or more functional groups selected from the group consisting of carboxyl, cyano, amino, hydroxyl, nitrate, thiocyano, thiosulfate and vinyl groups, and dispersing the carbon nanotubes in water. In addition, Korean Patent Laid-Open Publication No. 2008-0015532 discloses adding a dispersant and PVA to carbon nanotubes to prepare a stable dispersion of the carbon nanotubes, and coating a polymer with the dispersion, thereby preparing an electrically conductive polymer film.

Meanwhile, the present invention discloses a new type of electrically conductive polymer filler containing carbon nanotubes and a preparation method thereof, in which electrically conductive carbon nanotubes alone or carbon nanotubes and nano-sized metal powders are dispersed in a resin to prepare microcapsules, so that the electrically conductive polymer filler can be mixed uniformly with a thermoplastic resin as a matrix in order to impart electrostatic dissipative properties to the thermoplastic resin.

### PRIOR ART DOCUMENTS

### Patent Documents

(Patent Document 1) Korean Patent Laid-Open Publication No. 1997-0006325
(Patent Document 2) Korean Patent Laid-Open Publication No. 1998-0068341
(Patent Document 3) Korean Patent Laid-Open Publication No. 2010-0058342
(Patent Document 4) Korean Patent Laid-Open Publication No. 2002-0095273
(Patent Document 5) Korean Patent Laid-Open Publication No. 2005-0097711
(Patent Document 6) Korean Patent Laid-Open Publication No. 2008-0015532

### TECHNICAL SOLUTION

The present invention has been made in an attempt to use carbon nanotubes as an electrically conductive polymer filler in the preparation of a thermoplastic resin having electrostatic dissipative properties, and it is an object of the present invention to provide a novel electrically conductive polymer filler containing carbon nanotubes, in which the carbon nanotubes are encapsulated with a resin, which can be easily mixed with a thermoplastic resin as a matrix, to form microcapsules, so that these carbon nanotubes can be dispersed uniformly in the thermoplastic resin.

Another object of the present invention is to provide an electrically conductive thermoplastic resin comprising said electrically conductive polymer filler containing carbon nanotubes.

To achieve the above objects, the present invention provides a novel electrically conductive polymer filler comprising carbon nanotubes, which has a structure as described below.

The present invention provides an electrically conductive polymer filler comprising carbon nanotube microcapsules, each comprising a carbon nanotube and a thermoplastic resin layer encapsulating the carbon nanotube.

In the electrically conductive polymer filler, the thermoplastic resin layer is not specifically limited and may be any thermoplastic resin that may be easily mixed with and dispersed in a thermoplastic resin. Specifically, the thermoplastic resin layer includes a thermoplastic homopolymer or copolymer produced by the polymerization of a monomer containing an addition-polymerizable ethylene group.

The electrically conductive polymer filler may further comprise metal nanoparticles, in which the metal nanoparticles are attached to the composite in the microcapsules or attached to the outer surface of the resin layer of the microcapsules.

In the electrically conductive polymer filler, the carbon nanotube microcapsule may further comprise a water-soluble polymer. In this case, the water-soluble polymer may be combined with the carbon nanotube to form a carbon nanotube/water-soluble polymer composite. Alternatively, the water-soluble polymer may also be mixed with the resin layer. In addition, a portion of the water-soluble polymer may be combined with the carbon nanotube, while the remaining portion of the water-soluble polymer may be contained in the resin layer.

The present invention also provides a method for preparing said electrically conductive polymer filler, the method comprising the steps of:

1) mixing 1 part by weight of carbon nanotubes with 0.1-2 parts by weight of a water-soluble polymer and 0.1-20 parts by weight of an emulsifier in 50-1,000 parts by weight of water, and then ultrasonically dispersing the carbon nanotubes to obtain a water dispersion of the carbon nanotubes (ultrasonic dispersion step); and

2) polymerizing 10-1,000 parts by weight of at least one monomer containing an addition-polymerizable ethylene group so as to encapsulate the carbon nanotubes with a thermoplastic resin layer produced from the monomer (polymerization step).

The present invention provides an electrically conductive thermoplastic resin composition comprising, based on 100 parts by weight of a thermoplastic resin, 0.1-30 parts by weight of said electrically conductive polymer filler.

### ADVANTAGEOUS EFFECTS

The carbon nanotube-containing electrically conductive polymer filler according to the present invention can be dispersed uniformly in a thermoplastic resin and can solve the problem of low adhesion between carbon nanotubes and a thermoplastic resin as a matrix. Thus, it can show excellent electrostatic dissipative properties, even when it comprises a small amount of carbon nanotubes. Carbon nanotubes are expensive, and thus it is evident that, if the use of a small amount of carbon nanotubes can show excellent electrostatic dissipative properties, it will be economically very advantageous.

In the method for preparing the electrically conductive polymer filler comprising the carbon nanotube microcapsules according to the present invention, the water-soluble polymer is used to prevent the agglomeration and precipitation of dispersed carbon nanotubes in the polymerization step of forming the resin layer and to maintain the dispersed state of the carbon nanotubes, thereby making it possible to encapsulate the carbon nanotubes with the resin to form microcapsules.

### MODE FOR CARRYING OUT THE INVENTION

Hereinafter, the present invention will be described in detail.

The present invention provides an electrically conductive polymer filler comprising carbon nanotube microcapsules, each of the carbon nanotube microcapsules comprising a carbon nanotube and a thermoplastic resin layer encapsulating the carbon nanotube.

As used herein, the expression “carbon nanotube microcapsules” refers to micro-sized particles which contain carbon nanotubes encapsulated with a resin layer. The size of the microcapsules according to the present invention is in the range of 0.1 to 1000 μm, and preferably 1 to 500 μm. However, the size of the microcapsules may vary depending on the conditions used in the preparation process.

In the electrically conductive polymer filler, the thermoplastic resin layer is not specifically limited and may be made of any resin that may be mixed with and dispersed in a thermoplastic resin. Preferably, the thermoplastic resin layer includes a thermoplastic homopolymer or copolymer produced by the polymerization of a monomer containing an addition-polymerizable ethylene group.

The electrically conductive polymer filler may further comprise metal nanoparticles. The metal nanoparticles may be attached to the composite in the microcapsules or may be attached to the surface of the resin layer of the microcapsules.

In the electrically conductive polymer filler, the carbon nanotube microcapsules may further comprise a water-soluble polymer. In this case, the water-soluble polymer may be combined with the carbon nanotubes to form a carbon nanotube/water-soluble polymer composite. Alternatively, the water-soluble polymer may be mixed with the resin layer. Alternatively, a portion of the water-soluble polymer may be combined with the carbon nanotubes, while the remaining portion of the water-soluble polymer may be contained in the resin layer.

Hereinafter, the components of the electrically conductive polymer filler will be described in detail.

1. Carbon Nanotubes

The carbon nanotubes are meant to include all types of carbon, including single-walled carbon nanotubes (SWCNTs), double-walled carbon nanotubes (DWCNTs), multi-walled carbon nanotubes (MWCNTs) and roped carbon nanotubes. The carbon nanotubes that are used in the present invention may be a mixture of two or more types of carbon nanotubes. In a specific embodiment of the present invention, multi-walled carbon nanotubes are used, but are not limited thereto, and all known types of carbon nanotubes may be used in the present invention.

2. Thermoplastic Resin Layer

The thermoplastic resin layer that is used in the present invention encapsulates the carbon nanotubes to form carbon nanotube microcapsules. The resin of the thermoplastic layer that is used in the present invention may be any thermoplastic resin which can be easily dispersed in a thermoplastic resin serving as a matrix resin in the preparation of the electrically conductive thermoplastic resin.

Although the thermoplastic resin layer may be made of any thermoplastic resin, the resin layer preferably comprises a thermoplastic homopolymer or copolymer which is produced by the addition polymerization of a monomer containing an addition-polymerizable vinyl group. In a specific embodiment of the present invention, the resin layer comprises a homopolymer or copolymer which is formed by the polymerization of at least one monomer selected from the group consisting of ethylene, vinyl, acrylic and methacrylic monomers. Examples of the copolymer include all types of copolymers, such as alternating, random, block and graft copolymers.

The thermoplastic resin layer in the electrically conductive polymer filler is used in an amount that encapsulates the carbon nanotubes to form microcapsules. In a specific embodiment of the present invention, the thermoplastic resin layer may be included in the microcapsules in an amount of 10-1,000 parts by weight based on 1 part by weight of the carbon nanotubes.

If the thermoplastic resin layer is used in an amount of less than 10 parts by weight, it cannot sufficiently encapsulate the carbon nanotubes so as not to provide the desired microcapsules which are not dispersed uniformly when they are used in the preparation of the electrically conductive thermoplastic resin. If the thermoplastic resin layer is used in an amount of less than 1,000 parts by weight, the content of the carbon nanotubes in the electrically conductive polymer filler will be excessively low, such that an excessively large amount of the filler will be required in the preparation of the electrically conductive thermoplastic resin, and thus will be difficult to mix and will make it difficult to impart desired properties to the thermoplastic resin. In addition, it will be difficult to form the resin layer in an amount of 1,000 parts by weight through a process such as a polymerization process.

Examples of the ethylene monomer include ethylene, propylene, 1,3-butadiene, isobutylene, isoprene, styrene, α-methyl styrene and the like. Examples of the vinyl monomer include halogenated vinyl monomers, such as vinyl chloride, vinylidene chloride, and tetrafluoroethylene, vinyl C₁-C₁₀ alkylates (CH₂CH—OC(O)R wherein R is C₁-C₁₀ alkyl), including vinyl acetate, vinyl C₁-C₁₀ alkyl esters (CH₂CH—OR wherein R is C₁-C₁₀ alkyl), vinylpyrrolidone, vinylcarbazole, and the like.

Specific examples of the acrylic monomer include acrylic acid, acrylonitrile, acryl amide, C₁-C₁₀ alkyl acrylate, and the like.

Specific examples of the methacrylic monomer include methacrylic acid, methacrylonitrile, methacryl amide, C₁-C₁₀ alkyl methacrylate, and the like.

Examples of the C₁-C₁₀ alkyl include methyl, ethyl, n-butyl, iso-butyl and 2-ethylhexyl.

3. Metal Nanoparticles

The electrically conductive polymer filler according to the present invention may comprise, based on 100 parts by weight of the carbon nanotubes, 0.001-10 parts by weight (preferably 0.005-1 part by weight) of metal nanoparticles. The size of the metal nanoparticles may, for example, be in the range of 10 to 250 nm. The metal nanoparticles may be located anywhere in the carbon nanotube microcapsules. In a specific embodiment, the metal nanoparticles are mainly located in the resin layer or on the outer surface of the resin layer. The metal nanoparticles are additionally or optionally included to improve the electrostatic dissipative properties of the polymer filler. Thus, the content of the metal nanoparticles is not specifically limited, but is preferably 0.001-10 parts by weight in view of the preparation process.

The metal nanoparticles are prepared in a powder or paste form.

The metal of the metal nanoparticles that may be used in the present invention one or more metals having excellent electrical conductivity, such as silver, nickel or tungsten.

Depending on the time point of addition of the metal nanoparticles during the preparation process, the metal nanoparticles may be attached to the carbon nanotube/water-soluble block copolymer composite inside the resin layer of the microcapsules or may be attached to the outer surface of the resin layer.

Specifically, when the metal nanoparticles are added before the polymerization step for forming the resin layer, they may be attached to the composite in the resin layer, and when they are added after the polymerization step, they may be attached to the outer surface of the resin layer. This attachment of the metal nanoparticles will additionally be described in the description of the preparation method, which appears later in this specification.

4. Water-Soluble Polymer

The water-soluble polymer may be any water-soluble polymer. The role of the water-soluble polymer and the reason for the addition of the water-soluble polymer will be described in detail in the description of the preparation method, which appears later in this specification.

The water-soluble polymer may be included in the carbon nanotube microcapsules. The individual carbon nanotube microcapsules may include or not include the water-soluble polymer, but a floc of the carbon nanotube microcapsules usually includes the water-soluble polymer.

The content of the water-soluble block copolymer in the electrically conductive polymer filler composed of a floc of the carbon nanotube microcapsules is not specifically limited. However, in a specific embodiment of the present invention, the water-soluble block copolymer may be contained in an amount of 0.1-2 parts by weight based on 1 part by weight of the carbon nanotubes.

As used herein, the term “water-soluble polymer” means a polymer that can dissolve in water. Specifically, the water-soluble polymer may be a homopolymer or copolymer having a hydrophilic chain. Alternatively, the water-soluble polymer may be an amphiphilic copolymer containing a hydrophilic chain and a hydrophobic chain.

The repeating units of the hydrophilic chain in the water-soluble polymer include a functional group selected from among carboxyl, carboxylate, amino, phosphoric acid, phosphate, sulfuric acid, sulfate, alcohol, thiol, ester, amide, ether, ketone and aldehyde groups.

The repeating units of the hydrophilic chain in the water-soluble polymer that is used in the present invention preferably include a functional group selected from among a carboxyl group, a metal salt of carboxylic acid, and an ether group. The water-soluble polymer that is used in the present invention may include a hydrophobic chain moiety in the copolymer having the functional group. In other words, it may be a copolymer having a hydrophilic chain and a hydrophobic chain in the repeating units comprising the functional group. Examples of the copolymer include alternating, random, block and graft copolymers, preferably alternating copolymers. The hydrophobic chain moiety that is used in the present invention is hydrophobic relative to the hydrophilic chain moiety of the copolymer. Thus, examples of the water-soluble polymer include not only completely hydrophobic polymers, such as PE (polyethylene), PP (polypropylene), PS (polystyrene), PVC (polyvinyl chloride), PA (polyacrylate), PMA (polymethacrylate) and the like, but also PPO (polypropylene oxide), polyacrylate or its derivatives, polymethacrylate or its derivatives, and polyvinyl acetate.

Specific examples of the water-soluble polymer include homopolymers having repeating units containing a hydrophilic functional group, such as polyvinyl alcohol, PEO (polyethylene oxide), PPO (polypropylene oxide), PAA (polyacrylic acid), or salts thereof, and copolymers having repeating units containing a hydrophilic functional group, such as poly(ethylene oxide-b-propylene oxide) (PEO-b-PPO). In the poly(ethylene oxide-b-propylene oxide) (PEO-b-PPO), PPO is hydrophobic relative to PEO and functions as a hydrophobic chain. Meanwhile, examples of the copolymer having a hydrophilic chain and a hydrophobic chain in the repeating units containing a hydrophilic functional group include polystyrene-b-poly acrylic acid (PS-b-PAA). The poly(ethylene oxide-b-propylene oxide) that may be used in the present invention may be selected from among commercial copolymers prepared to have various EO:PO ratios such as 0.15:1, 0.33:1, and 0.8:1. In the amphiphilic copolymer, the ratio of the hydrophilic chain to the hydrophobic chain is not specifically limited, but in a specific embodiment of the present invention, the ratio of hydrophilic chain:hydrophobic chain may be 0.0.5:1 to 10:1.

If an amphiphilic block copolymer containing a hydrophilic chain and a hydrophobic chain in the polymer molecular is used as the water-soluble polymer, the dispersion stability of the carbon nanotubes can further be increased. In other words, a structure similar to a kind of micelle can be formed in which the hydrophobic chain is exposed to the carbon nanotubes and the hydrophilic chain is exposed to water.

The water-soluble polymer has a molecular weight of 1,000-200,000, and preferably 1,000-100,000.

Hereinafter, the method for preparing the carbon nanotube-containing electrically conductive polymer filler according to the present invention will be described in detail.

The method for preparing the carbon nanotube-containing electrically conductive polymer filler according to the present invention may comprise the steps of: 1) mixing 1 part by weight of carbon nanotubes with 0.1-2 parts by weight of a water-soluble polymer and 0.1-20 parts by weight (preferably 1-10 parts by weight) of an emulsifier in 50-1,000 parts by weight of purified water or pure water, and then dispersing the carbon nanotubes by a sonicator, thereby obtaining a dispersion of a carbon nanotube/water-soluble block copolymer composite (ultrasonic dispersion step); and 2) polymerizing 10-1,000 parts by weight, based on 1 part by weight of the carbon nanotubes, of a thermoplastic resin monomer so as to encapsulate the carbon nanotubes with a thermoplastic resin layer produced from the monomer (polymerization step).

Furthermore, the preparation method may further comprise, after the polymerization step, a step of flocculating the produced microcapsules to form a floc (flocculation step).

In addition, the preparation method may further comprise, after the flocculation step, a step of heating the floc to the glass transition temperature (Tg) or higher of the resin produced by the polymerization, cooling the heated floc and crushing the cooled floc (crushing step).

Hereinafter, the preparation method will be described in detail.

1. Ultrasonic Dispersion Step

The role of the water-soluble polymer that is used in the ultrasonic dispersion step is as follows.

The present invention provides a method of preparing microcapsules by encapsulating dispersed carbon nanotubes with a resin layer by polymerization. Meanwhile, with respect to a method of dispersing carbon nanotubes in a solvent, an ultrasonic dispersion method is already well known. However, carbon nanotubes dispersed by ultrasonication after mixing with an emulsifier have a strong tendency to agglomerate again.

Thus, if an attempt to encapsulate carbon nanotubes with a thermoplastic resin layer by emulsion polymerization is made after ultrasonically dispersing the carbon nanotubes only with an emulsifier, desired carbon nanotube microcapsules cannot be obtained due to the re-agglomeration and precipitation of the carbon nanotubes.

Thus, in order to prevent the re-agglomeration and precipitation of carbon nanotubes and to prepare carbon nanotube microcapsules by encapsulating the carbon nanotubes with a resin layer through a polymerization step, continuously maintaining the dispersed state of the carbon nanotubes is absolutely required.

In the process of preparing the carbon nanotube microcapsules according to the present invention, carbon nanotubes can be encapsulated with a thermoplastic resin layer by, for example, emulsion polymerization. For this purpose, it is required to prevent the water-soluble polymer from aggregating between the carbon nanotubes such that the dispersed state of the carbon nanotubes can be maintained.

Meanwhile, when an amphiphilic water-soluble polymer containing a hydrophobic chain moiety is used as the water-soluble polymer, the hydrophobic moiety will be located in the carbon nanotubes, and the hydrophilic moiety will be located in the water phase, thereby forming a kind of micelle that can more easily maintain the dispersed state of the carbon nanotubes.

In the ultrasonic dispersion step of the preparation method, metal nanoparticles may be added before ultrasonic dispersion. In this case, the metal nanoparticles will be present inside the resin layer of the microcapsules that are produced in the polymerization step. Of course, the metal nanoparticles may also be located in the resin layer during the polymerization process. Preferably, the metal nanoparticles have a size of 10-250 nm and are added in an amount of 0.01-10 parts by weight based on 100 parts by weight of the carbon nanotubes. The metal nanoparticles may be made of one or more metals having excellent electrical conductivity, such as silver, nickel or tungsten.

2. Polymerization Step

In the preparation method, the polymerization reaction can be carried out according to a known polymerization process such as suspension polymerization or emulsion polymerization. Preferably, it may be performed under emulsion polymerization conditions.

The polymerization reaction can be suitably performed by a person skilled in the art under known reaction conditions.

In a specific embodiment of the preparation method according to the present invention, the polymerization reaction may be performed under the following conditions.

The polymerization reaction is preferably an emulsion polymerization reaction and is preferably carried out at a temperature of 0˜280° C., and more preferably 40˜120° C. An emulsifier that may be used to perform emulsion polymerization is not specifically limited and may be selected from among various emulsifiers known in the art. Examples of the emulsifier that may be used in the present invention include anionic surfactants such as alkyl sulfuric esters, alkylbenzene sulfonates, alkyl phosphoric esters, or dialkylsulfosuccinates; nonionic surfactants such as polyoxyethylene alkylether, polyoxyethylene fatty acid ester, sorbitol fatty acid ester, or glycerol fatty acid ester; cationic surfactants such as alkylamine salts; and amphiphilic surfactants. However, the emulsifier may be the emulsifier used in the water dispersion step and may be may be used in the polymerization reaction in a state in which it is contained in a dispersed solution for supplying an additional monomer.

Specific examples of the emulsifier include sodium dodecyl sulfate, sodium dodecyl benzene sulfate, polyoxyethylene alkyl ether (alkyl alcohol ethoxylate), sodium dioctyl sulfosuccinate, polyoxyethylene alkylether sulfate salts, Tween series emulsifiers such as polysorbate 20 or 80, or Triton X-100. These emulsifiers are merely examples of commercial emulsifiers, and all known emulsifiers may be used without particular limitations in the present invention.

Before the polymerization step, the water dispersion solution obtained by ultrasonication is introduced into a reactor, after water has, if necessary, been added thereto. The solution in the reactor is continuously stirred.

The monomer to be polymerized is dispersed uniformly in water together with an emulsifier and then introduced into the reactor. The emulsifier that is used for the dispersion of the monomer is preferably the same emulsifier used in the ultrasonic dispersion step.

100 parts by weight of the monomer is mixed with 1-20 parts by weight of the emulsifier in 50-300 parts by weight of water and then stirred. The resulting dispersion is added slowly to the reactor.

After addition of the monomer, a polymerization initiator is added to initiate the polymerization of the monomer.

The polymerization initiator that is used in the present invention may be a water-soluble initiator, an oil-soluble initiator, or a redox initiator. Specific examples of the water-soluble initiator include inorganic initiators such as persulfate, and specific examples of the oil-soluble initiator include organic peroxides such as benzoyl peroxide, o-chlorobenzoyl peroxide, o-methoxybenzoyl peroxide, lauroyl peroxide, octanoyl peroxide, methyl ethyl ketone peroxide, diisopropylperoxy dicarbonate, cyclohexanone peroxide, t-butyl hydroperoxide or diisopropylbenzene hydroperoxide; azo-nitrile compounds, non-cyclic azo-amidine compounds, cyclic azo-amidine compounds, azo-amide compounds, azo-alkyl compounds, or azo-ester compounds. One or more selected from among these initiators may be used in the present invention.

The polymerization initiator is preferably used in an amount of 0.001-10 parts by weight, and more preferably 0.001-1 part by weight, based on 100 parts by weight of the monomer.

The flocculation step of flocculating the microcapsules formed in the polymerization step will now be described in detail.

In the flocculation step, the formed microcapsules can be flocculated using a known method such as filtration, dialysis or salting-out. Preferably, the salting-out method is used.

In the salting-out method, a flocculant is added to form a floc. The flocculant that is used in the present invention is a mono-, di- or tri-valent metal salt, or an acid such as sulfuric acid or acetic acid. Specific examples of the metal salt include CaCl₂, MgSO₄ or Al₂(SO₄)₃. The flocculated microcapsules are collected by centrifugation. Meanwhile, the microcapsule floc obtained in the flocculation step is preferably dried to remove water.

Meanwhile, the flocculant may be added at the same time as metal nanoparticles. In this case, the metal nanoparticles may be attached to the outer surface of the resin layer of the microcapsules.

The metal nanoparticles have been described above with respect to the ultrasonic dispersion step, and thus the detailed description thereof will be omitted.

The metal nanoparticles may be added in the ultrasonic dispersion step or in the flocculation step, thereby preparing the inventive carbon nanotube-containing electrically conductive polymer filler which further comprises the metal nanoparticles.

The dried microcapsule floc may be heated and crushed to a desired size.

The crushing step may be performed using a known crushing process such as knife cutting or milling. The average particle diameter of the product obtained in the crushing step is preferably 0.05-2.00 mm, and more preferably 0.10-1.00 mm.

The electrically conductive polymer filler obtained according to the above preparation method may, if necessary, be added to a thermoplastic resin in various amounts, followed by extrusion, thereby producing an electrically conductive thermoplastic resin.

It will be obvious that, in addition to the electrically conductive polymer filler according to the present invention, additives for obtaining other properties, such as a flame retardant, may be added.

To the electrically conductive thermoplastic resin composition obtained by mixing 0.1-30 parts by weight of the electrically conductive polymer filler of the present invention with 100 parts by weight of the thermoplastic resin, other additives for an extrusion process may be added, after which the resulting mixture can be extruded using a known extrusion process, thereby preparing an electrically conductive thermoplastic resin. When the electrically conductive polymer filler is used in an amount of 0.5-2 parts by weight based on 100 parts by weight of the thermoplastic resin, a sufficient surface resistivity can be obtained, and if the filler is used in an amount of 10-30 parts by weight, it can also be used as a master batch.

The thermoplastic resin may be one resin or a mixture of two or more selected from the group consisting of polyacetal resin, acrylic resin, polycarbonate resin, styrene resin, polyester resin, vinyl resin, polyphenylene ether resin, polyolefin resin, acrylonitrile-butadiene-styrene copolymer resin, polyacrylate resin, polyamide resin, polyamideimide resin, polyarylsulfone resin, polyetherimide resin, polyethersulfone resin, polyphenylene sulfide resin, fluorine-based resin, polyimide resin, polyetherketone resin, polybenzoxazole resin, polyoxadiazole resin, polybenzothiazole resin, polybenzimidazole resin, polypyridine resin, polytriazole resin, polypyrrolidine resin, polydibenzofuran resin, polysulfone resin, polyurea resin, polyphosphagen resin, and liquid crystal polymer resin, or may be selected from among copolymers obtained by the copolymerization of two or more of monomers corresponding to the above-mentioned resins.

The present invention also provides an electrically conductive polymer filler-containing composition prepared by the above-described method.

Hereinafter, the present invention will be described with reference to examples. It is to be understood, however, that these examples are provided for a better understanding of the present invention and are not intended to limit the scope of the present invention.

### Example 1

1 g of a water-soluble block copolymer consisting of poly(ethylene oxide-b-propylene oxide) obtained by copolymerizing ethylene oxide and propylene oxide at a ratio of 0.15:1 was added to 100 g of pure water in a beaker, after which the mixture was stirred with a homogenizer for about 10 minutes. To the stirred solution, 1 g of multi-walled carbon nanotubes (TM-100; commercially available from Hanwha Nanotech, Korea) and 4 g of the emulsifier sodium dodecyl benzene sulfate (EU-SA210L; Dongnam Chemical Co., Ltd., Korea) were added and ultrasonically dispersed for about 2 hours.

The ultrasonically dispersed solution was added to a polymerization reactor, and 400 g of pure water was added thereto, followed by stirring at a temperature of 55° C. at a speed of 300 rpm. Then, a mixed solution of 80 g of a styrene monomer, 20 g of an acrylonitrile monomer, 8 g of the emulsifier sodium dodecyl benzene sulfate and 100 g of pure water was stirred with a homogenizer for about 10 minutes, and then introduced slowly into the reactor containing the dispersed solution. The content in the reactor was stirred for about 30-60 minutes, 1 g of the polymerization initiator benzoyl peroxide diluted in 40 g of pure water was introduced into the reactor to initiate the polymerization of the monomers. Herein, the polymerization temperature was set at 70° C. The styrene and acrylonitrile monomers were polymerized around the carbon nanotube particles dispersed by the water-soluble copolymer, thereby forming microcapsules. The emulsion containing the formed microcapsules were flocculated by addition of magnesium sulfate (MgSO₄), and then heated to 100° C. while it was subjected to high-speed rotation, so that the flocculated grains had a specific level of strength. Then, the flocculated grains were washed several times with pure water and dried, thereby obtaining a floc of an electrically conductive polymer filler formed by the flocculation of the microcapsules. 100 g of the floc was compounded with 1,000 g of polycarbonate resin and extruded, thereby preparing an electrically conductive thermoplastic resin.

### Example 2

An electrically conductive thermoplastic resin was prepared in the same manner as Example 1, except that 0.01 g of silver (Ag) powder having an average particle size of 20 nm was added to 1 g of carbon nanotubes which were then ultrasonically dispersed. As the emulsifier, SDS (sodium dodecyl sulfate) was used.

### Example 3

An electrically conductive thermoplastic resin was prepared in the same manner as Example 1, except that 100 g of methyl methacrylate and 50 g of butyl methacrylate were polymerized instead of the styrene and acrylonitrile monomers.

As the emulsifier, Triton X-100 was used.

### Example 4

An electrically conductive thermoplastic resin was prepared in the same manner as Example 1, except that the flocculant magnesium sulfate (MgSO₄) together with 0.01 g of silver (Ag) powder having an average particle size was added to the emulsion containing the formed microcapsules after completion of the polymerization. As the emulsifier, M-LE1050 (lauryl alcohol ethoxylate; commercially available from Sameul Moolsan Co., Ltd., Korea) was used.

### Example 5

An electrically conductive thermoplastic resin was prepared in the same manner as Example 1, except that 40 g of styrene and 10 g of acrylonitrile were used. As the emulsifier, EU-D0113 (sodium dioctyl sulfosuccinate; commercially available from Dongnam Chemical Co., Ltd., Korea) was used.

### Example 6

An electrically conductive thermoplastic resin was prepared in the same manner as Example 1, except that PEO (polyethylene oxide) was used as the water-soluble polymer. As the emulsifier, EU-S75D (polyoxyethylene alkyl ether sulfate salt; commercially available from Dongnam Chemical Co., Ltd., Korea) was used.

### Example 7

An electrically conductive thermoplastic resin was prepared in the same manner as Example 1, except that PAA (polyacrylic acid) was used as the water-soluble polymer.

### Example 8

An electrically conductive thermoplastic resin was prepared in the same manner as Example 1, except that PS-b-PAA (poly(styrene-b-acrylic acid)) was used as the water-soluble polymer. As the emulsifier, Tween 20 was used.

### Example 9

An electrically conductive thermoplastic resin was prepared in the same manner as Example 3, except that 300 g of methyl methacrylate and 150 g of butyl methacrylate were used. As the emulsifier, Tween 80 was used.

### Comparative Example 1

An attempt to prepare an electrically conductive polymer filler in the same manner as Example without using the water-soluble block copolymer was made. However, the dispersion of the carbon nanotubes was not maintained in the polymerization step, and the carbon nanotubes agglomerated together to form a precipitate, and thus microcapsules containing the carbon nanotubes were not obtained. As a result, an electrically conductive thermoplastic resin could not be prepared.

### Comparative Example 1

A composition obtained by mixing 1,000 g of polycarbonate resin with 10 g of carbon nanotubes was extruded to prepare an electrically conductive thermoplastic resin.

### Test Example 1

### SEM Photograph of Carbon Nanotube Microcapsules

The carbon nanotube microcapsules prepared in Example 1 were separated, dried and then photographed with SEM.

The SEM photograph showed that the microcapsules were spherical particles having an average size of about 20 μm.

### Test Example 2

### Measurement of Surface Resistivity of Electrically Conductive Thermoplastic Resin

The electrically conductive thermoplastic resins obtained in the Examples and the Comparative Examples were injection-molded into discs having a diameter of 100 mm and a thickness of 3 mm, and then the surface resistivities of the discs were measured. The results of the measurement are shown in Table 1 below.

TABLE 1
Compositions of electrically conductive thermoplastic
resins and the measured surface resistivities thereof

| | | | | | | Comp. | Comp. |
|---|---|---|---|---|---|---|---|
| | Example 1 | Example 2 | Example 3 | Example 4 | Example 5 | Example 1 | Example 2 |
| Carbon | 1 g | 1 g | 1 g | 1 g | 1 g | 1 g | 10 g |
| nanotubes | | | | | | | |
| PEO-b-PPO | 1 g | 1 g | 1 g | 1 g | 1 g | | |
| Styrene | 80 g | 80 g | | 80 g | 40 g | 80 g | |
| Acrylonitrile | 20 g | 20 g | | 20 g | 10 g | 20 g | |
| Methyl | | | 100 g | | | | |
| methacrylate | | | | | | | |
| Butyl | | | 50 g | | | | |
| methacrylate | | | | | | | |
| Silver | | 0.01g | | | | | |
| nanoparticles | | | | | | | |
| Ag in | | | | 0.01g | | | |
| flocculation | | | | | | | |
| Carbon | 100 g | 100 g | 100 g | 100 g | 50 g | | |
| nanotube- | | | | | | | |
| containing | | | | | | | |
| microcapsules | | | | | | | |
| (on a dry basis) | | | | | | | |
| PC | 1000 g | 1000 g | 1000 g | 1000 g | 1000 g | | 1000 g |
| Surface | 2.5 × 10⁸ | 4.3 × 10⁵ | 4.7 × 10⁸ | 5.7 × 10⁶ | 2.7 × 10⁸ | — | 2.6 × 10¹² |
| resistivity | | | | | | | |
| (Ω/sq) | | | | | | | |
| Remarks | | Addition of | | Addition of | | Failed in | |
| | | silver | | silver | | production of | |
| | | nanoparticles | | nanoparticles | | microcapsules | |
| | | during | | during | | due to | |
| | | dispersion | | flocculation | | agglomeration | |
| | | | | | | of carbon | |
| | | | | | | nanotubes | |

In Comparative Example 1, carbon nanotube-containing microcapsules composed of a resin encapsulating carbon nanotubes were not obtained. As a result, an electrically conductive thermoplastic resin could not be prepared, and thus the measurement of surface resistivity could not be performed.

In Examples 1 to 4, the contents of the carbon nanotubes in the electrically conductive thermoplastic resins could not be accurately determined, but were obviously less than 1 g. This is because 100 g or more of the filler was obtained using 1 g of the carbon nanotubes.

Thus, in the Examples, while the carbon nanotubes were used in an amount corresponding to less than 1/10 of that in Comparative Example 1, the surface resistivity of the resins could be increased by about 10⁴ (10,000) times. In addition, when the carbon nanotubes were used together with the metal nanoparticles, the surface resistivity could be increased by about 5×10⁶ times.

What is claimed is:

1. An electrically conductive polymer filler comprising carbon nanotube microcapsules, each comprising a carbon nanotube and a thermoplastic resin layer encapsulating the carbon nanotube, wherein the electrically conductive polymer filler is obtained as a floc of the microcapsules.

2. The electrically conductive polymer filler of claim 1, wherein the thermoplastic resin layer is included in an amount of 10-1,000 parts by weight based on 1 part by weight of the carbon nanotube and comprises a thermoplastic homopolymer or copolymer produced by polymerization of one or more monomers containing an addition-polymerizable ethylene group.

3. The electrically conductive polymer filler of claim 1, wherein the electrically conductive polymer filler further comprises metal nanoparticles in an amount of 0.001-10 parts by weight based on 1 part by weight of the carbon nanotube.

4. The electrically conductive polymer filler of claim 1, wherein the carbon nanotube is one or a mixture of two or more selected from the group consisting of single-walled carbon nanotubes, double-walled carbon nanotubes, multi-walled carbon nanotubes, and roped carbon nanotubes.

5. The electrically conductive polymer filler of claim 2, wherein the one or more monomers containing the ethylene group include one or more monomers selected from the group consisting of an ethylene monomer, a vinyl monomer, an acrylic monomer and a methacrylic monomer, wherein the ethylene monomer includes one or more selected from the group consisting of ethylene, propylene, 1,3-butadiene, butadiene, isobutylene, isoprene, styrene, and α-methyl styrene, the vinyl monomer includes one or more selected from the group consisting of vinyl chloride, vinylidene chloride, tetrafluoroethylene, vinyl C₁-C₁₀ alkylates (CH₂CH—OC(O)R wherein R is C₁-C₁₀ alkyl), vinyl C₁-C₁₀ alkyl esters (CH₂CH—OR wherein R is C₁-C₁₀ alkyl), vinylpyrrolidone, and vinylcarbazole, the acrylic monomer includes one or more selected from the group consisting of acrylic acid, acrylonitrile, acryl amide, and C₁-C₁₀ alkyl acrylate, and the methacrylic monomer includes one or more selected from the group consisting of methacrylic acid, methacrylonitrile, methacryl amide, and C₁-C₁₀ alkyl methacrylate.

6. The electrically conductive polymer filler of claim 3, wherein the metal nanoparticles include one or more selected from the group consisting of silver, nickel and tungsten.

7. The electrically conductive polymer filler of claim 1, wherein the electrically conductive polymer filler further comprises, based on 1 part by weight of the carbon nanotube, 0.1-2 parts by weight of a water-soluble polymer.

8. An electrically conductive thermoplastic resin composition comprising, based on 100 parts by weight of a thermoplastic resin, 0.1-30 parts by weight of the electrically conductive polymer filler of claim 1.

9. The electrically conductive thermoplastic resin composition of claim 8, wherein the thermoplastic resin is one or a mixture of two or more selected from the group consisting of polyacetal resin, acrylic resin, polycarbonate resin, styrene resin, polyester resin, vinyl resin, polyphenylene ether resin, polyolefin resin, acrylonitrile-butadiene-styrene copolymer resin, polyacrylate resin, polyamide resin, polyamideimide resin, polyarylsulfone resin, polyetherimide resin, polyethersulfone resin, polyphenylene sulfide resin, fluorine-based resin, polyimide resin, polyetherketone resin, polybenzoxazole resin, polyoxadiazole resin, polybenzothiazole resin, polybenzimidazole resin, polypyridine resin, polytriazole resin, polypyrrolidine resin, polydibenzofuran resin, polysulfone resin, polyurea resin, polyphosphagen resin, and liquid crystal polymer resin, or is selected from among copolymers obtained by copolymerization of two or more of monomers corresponding to these resins.

10. A method for preparing an electrically conductive polymer filler according to claim 1, the method comprising the steps of:
1) mixing 1 part by weight of carbon nanotubes with 0.1-2 parts by weight of a water-soluble polymer and 0.1-20 parts by weight of an emulsifier in 50-1,000 parts by weight of water, and then ultrasonically dispersing the carbon nanotubes to obtain a water dispersion of the carbon nanotubes (ultrasonic dispersion step);
2) polymerizing 10-1,000 parts by weight, based on 1 part by weight of the carbon nanotubes, of one or more monomers containing an addition-polymerizable ethylene group so as to encapsulate the carbon nanotubes with a thermoplastic resin layer produced from the monomers, thereby forming microcapsules (polymerization step); and
3) flocculating the produced microcapsules to form a floc (flocculation step).

11. The method of claim 10, wherein the method further comprises, after the flocculation step, a step of heating the floc to the glass transition temperature (Tg) or higher of the resin produced by the polymerization, cooling the heated floc and crushing the cooled floc (crushing step).

12. The method of claim 10, wherein the polymerization is emulsion polymerization.
